(19) United States
(12) Patent Application Publication
(10) Pub. No.: US 2004/0178306 A1
(43) Pub. Date: Sep. 16, 2004

(54) Self-stabilizing telescopic leg

(76) Inventor: Edwin A. Hallberg, Midland, MI (US)

Correspondence Address: David M. Thimmig, MAYER, BROWN, ROWE & MAW, P.O. Box 2828, Chicago, IL, 60690-2828, US

(21) Appl. No.: 10/388,932

(22) Filed: Mar. 14, 2003

(51) Int. Cl. F16M 11/26

(52) U.S. Cl. 248/188.5

(57) ABSTRACT

A self-stabilizing telescopic leg assembly for use in supporting a portion of a platform assembly above a floor surface. The telescopic leg assembly has at least one first leg portion slidably engaging at least one second leg portion. The leg assembly also has at least one pin adapted to simultaneously engage a hole passing laterally through the first leg portion and an angled slot passing laterally through the second leg portion, wherein when the leg assembly is in a vertical orientation, the pin transfers a vertical load from the first leg portion to the second leg portion and causes engagement between the first and second leg portions in a direction at an angle to the vertical orientation of the leg portions.

### BACKGROUND OF THE INVENTION

1. Field of the Invention

The present invention generally relates to leg devices for load carrying platforms, such as in portable staging and seating equipment. More particularly, the invention relates to a telescopic leg assembly which includes a self-stabilizing feature for use in supporting a portion of a platform assembly above a floor surface.

2. Discussion of the Prior Art

Portable platform assemblies are widely used, such as for staging equipment in auditoriums, gymnasiums, and event halls to accommodate performers or spectators on an as needed basis. Depending on the intended use, a facility may require such equipment to be moved between use and storage positions on a repeated basis. Manufacturers often incorporate wheels on such equipment, usually of the caster wheel type, for use in moving the equipment from a storage location to a position for use as a platform. Sometimes each wheel has a break mechanism to park the equipment once positioned for use. The equipment may have wheels for moving the equipment, with legs alternatively deployed to increase the load capacity and limit the movement when the platform is positioned for use.

For maximum flexibility in use, whether using legs to increase load carrying capacity or using legs with wheel mechanisms, leg structures may also need to be adjustable in length to facilitate use of the equipment at alternative heights. Hence, it is desirable to have a telescopic leg assembly which permits a load carrying platform assembly, once moved to its location for use, to be supported at one or more different heights.

Telescopic leg structures usually include at least one outer tube having a given inside diameter, and at least one inner tube having a given outside diameter that is less than the inside diameter of the outer tube. This relationship permits slidable movement of the inner tube relative to the outer tube during telescopic leg length adjustment. Typically the outer tube has a single hole passing laterally through its side wall while the inner tube may have a series of longitudinally spaced apart holes passing laterally through the side wall, or vice versa. The respective holes permit a pin to be used to selectively temporarily fix the position of the inner tube relative to the outer tube. Unfortunately, the clearance needed for slidable movement between the inner and outer tubes also tends to cause a telescopic leg to wobble when loads shift on the platform, causing the inner tube to rock back and forth on the pin within the outer tube. The wobbling can be unsettling to persons stepping onto, standing or moving atop such a platform assembly or to those watching performers on such a platform assembly. This also can reduce the assembly's overall safe load carrying capacity.

Thus, it is desirable to have telescopic legs on platform assemblies, but the typical structure of a telescopic leg is not conducive to the feeling or sense of stability desired in platform assemblies. Hence, it is desirable that the telescopic leg assembly of the present invention permit adjustment in length but also be self-stabilizing to reduce wobbling and enhance the load carrying capacity.

The telescopic leg assembly of the present invention could be adapted for use with a platform assembly where the telescopic leg also may be folded toward the platform for reduced space requirements during storage or may be in a fixed position perpendicular to the plane of the platform.

It is further advantageous to achieve simple operation of such a self-stabilizing telescopic leg, to enhance reliability and serviceability, and to make it possible for the leg length to be quickly adjusted by unskilled individuals, without tools. Therefore, it is advantageous for such a leg assembly to incorporate only an adjustment pin and to not require further adjustment or clamping hardware to force the telescopic leg portions into a self-stabilizing position.

The present invention overcomes disadvantages of the prior art, while providing the above mentioned desirable features in a self-stabilizing telescopic leg assembly.

### SUMMARY OF THE INVENTION

The purpose and advantages of the invention will be set forth in and apparent from the description and drawings that follow, as well as will be learned by practice of the invention.

The present invention is generally embodied in a self-stabilizing telescopic leg assembly for use with load carrying platforms, such as in staging or seating equipment. In a first aspect, the invention provides a self-stabilizing telescopic leg assembly having a plurality of leg portions. The leg assembly has at least a first leg portion having at least one hole passing laterally through the first leg portion. The leg assembly also has at least a second leg portion slidably engaging the first leg portion and having at least one angled slot passing laterally through the second leg portion. The leg assembly further comprises at least one pin adapted to simultaneously engage a hole passing laterally through the first leg portion and an angled slot passing laterally through the second leg portion, wherein when the leg assembly is in a vertical orientation the pin transfers a vertical load from the first leg portion to the second leg portion and causes engagement between the first and second leg portions in a direction at an angle to the vertical orientation of the leg portions.

In another aspect, the invention provides a platform assembly having at least one platform and a plurality of self-stabilizing telescopic leg assemblies connected to the at least one platform. Each of the plurality of legs has at least a first leg portion having at least one hole passing laterally through the first leg portion. Each leg assembly also has at least a second leg portion slidably engaging the first leg portion and having at least one angled slot passing laterally through the second leg portion. Each leg assembly also has at least one pin adapted to simultaneously engage a hole passing laterally through the first leg portion and an angled slot passing laterally through the second leg portion, wherein when the platform assembly is assembled for use with the platform in a horizontal plane, each leg assembly is in a vertical orientation and each pin transfers a vertical load from a first leg portion to a second leg portion and causes engagement between the first and second leg portions in a direction at an angle to the vertical orientation of the leg portions.

It is to be understood that both the foregoing general description and the following detailed description are exemplary and provided for purposes of explanation only, and are not restrictive of the invention, as claimed. Further features and objects of the present invention will become more fully apparent in the following description of the preferred embodiment and from the appended claims.

### BRIEF DESCRIPTION OF THE DRAWINGS

In describing the preferred embodiments, reference is made to the accompanying drawing figures wherein like parts have like reference numerals, and wherein:

FIG. 1 is a perspective view of an embodiment of a self-stabilizing telescopic leg assembly connected to a corner of a platform assembly.

FIG. 1A is a view of the outer tube of the telescopic leg assembly of FIG. 1, but with the slot through the tube being cut at a first angle through one side wall of the tube and at a second angle, perpendicular to the first, through the opposed side wall of the tube.

FIG. 2 is a perspective view of a platform assembly with a second embodiment of self-stabilizing telescopic leg assemblies having sliding pin mechanisms and with at least one leg assembly shown folded upward as may be done for storage along the bottom of the platform.

FIG. 3 is a perspective view of a third embodiment of a self-stabilizing telescopic.

FIG. 4 is a perspective view of a fourth embodiment of a self-stabilizing telescopic leg assembly.

It should be understood that the drawings are not to scale and that certain aspects are illustrated in phantom views. While considerable mechanical details of a self-stabilizing telescopic leg assembly, including details of fastening means and other plan and section views of the particular embodiments depicting the invention have been omitted, such details are not per se part of the present invention and are considered well within the comprehension of those skilled in the art in light of the present disclosure. It also should be understood that the present invention is not limited to the preferred embodiments illustrated.

### DETAILED DESCRIPTION OF THE PREFERRED EMBODIMENT

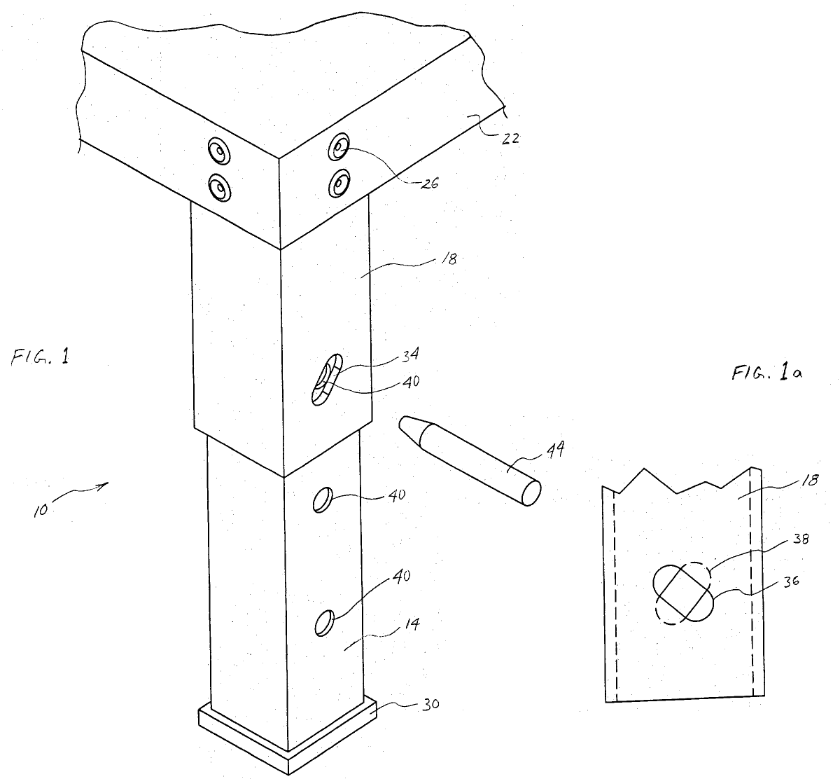

Referring generally to FIGS. 1, 1a and 2-4, it will be appreciated that the self-stabilizing telescopic leg assembly of the present invention generally may be embodied within numerous configurations for attachment to load carrying platform assemblies. It also will be appreciated that the self-stabilizing telescopic leg assemblies may be used to provide adjustment between two or more platform heights.

Referring to FIG. 1, the telescopic structure of each leg assembly 10 of the first embodiment includes at least a first leg portion 14 and a second leg portion 18. One of the two leg portions, in this case second leg portion 18, may be connected directly to a platform assembly 22. In this embodiment second leg portion 18 is fixedly connected to platform assembly 22, such as by conventional fasteners 26. Leg assembly 10 further includes at least a first leg portion 14 which slidably engages second leg portion 18. First leg portion 14 also has a foot pad 30 at its lower end for contact with a ground surface.

As shown in FIG. 1, first leg portion 14 and second leg portion 18 are preferably made from square metal tubing. Second leg portion 18 has interior wall dimensions that are slightly larger than the exterior perimeter wall dimensions of first leg portion 14. In this way, first leg portion 14 may be slidably received in second leg portion 18. Second leg portion 18 also has at least one angular slot 34 cut laterally through two opposed side walls. First leg portion 14 has a plurality of spaced-apart holes 40 cut laterally through its opposed side walls.

When a hole 40 cut through opposed side walls in first leg portion 14 is aligned with a slot 34 cut through opposed side walls in second leg portion 18, a pin 44 may be inserted to engage first leg portion 14 and second leg portion 18 and to lock them to each other. Though not shown, pin 44 may have a detent mechanism or other feature to enhance its ability to stay in position when inserted into one or more leg portions, and may have a tether to attach it to the assembly when not inserted. The pin and hole structures also permit selective use of the telescopic leg assemblies at various lengths.

When a vertical load is placed on the leg assembly 10, the pin 44 transfers vertical load from the first leg portion 14 to the second leg portion 18. Because the pin is in an angled slot 34 in second leg portion 18, the vertical load tends to cause engagement between the first and second leg portions in a direction at an angle to the vertical orientation of the leg portions 14 and 18. Thus, as pin 44 is made to ride higher in slot 34, it causes an exterior wall of first leg portion 14 to press against an interior wall of second leg portion 18. This engagement between wall surfaces reduces wobble of the first leg portion 14 within the second leg portion 18, making the leg assembly 10 more stable.

Shown in FIG. 1a is an alternative to the first embodiment with a slot 36 cut in one direction in one side wall and slot 38 preferably cut at a different angle in the opposed side wall of second leg portion 18. When used with a similar first leg portion 14 having lateral holes 40 and a pin 44, a vertical load causes first leg portion 14 to try to turn within second leg portion 18. The slight forced turning of first leg portion 14 within second leg portion 18 causes engagement between exterior side wall surfaces of first leg portion 14 with interior side wall surfaces of second leg portion 18. This alternative also results in reduced wobble within the leg assembly 10.

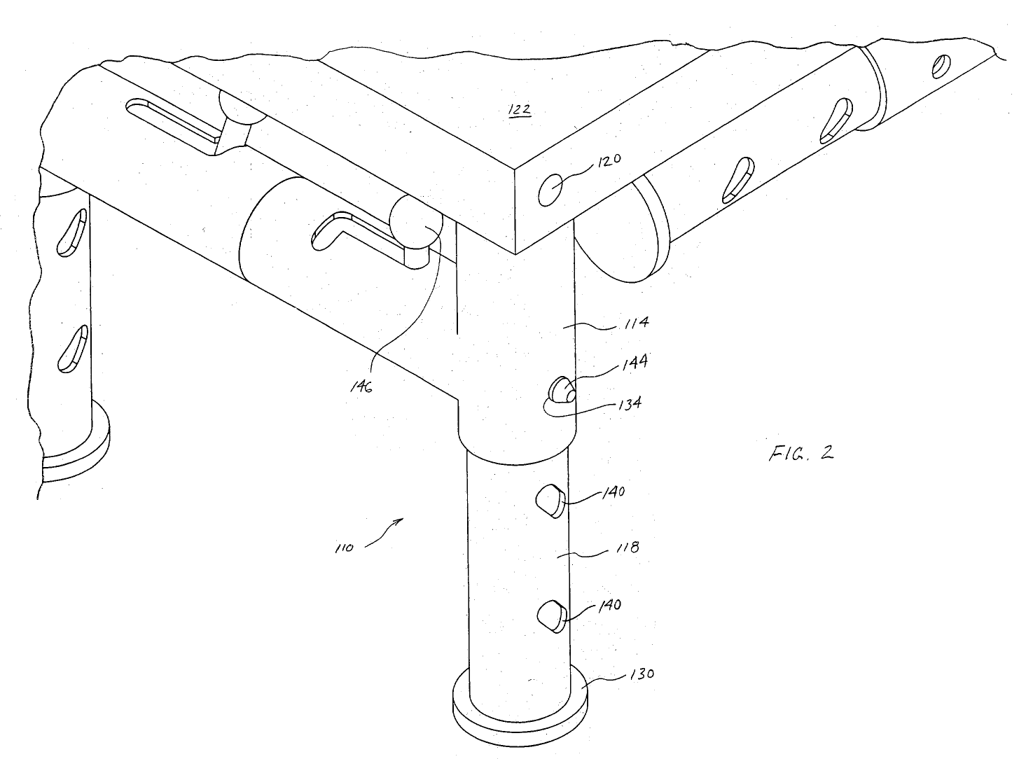

Turning now to FIG. 2, a telescopic leg assembly 110 of a second embodiment includes at least a first leg portion 114 and a second leg portion 118. The first leg portion 114 is connected directly to a platform assembly 122. However, in this second embodiment, first leg portion 114 is pivotally connected to platform assembly 122 for folding to a storage position, such as by conventional means at pivot 120.

In the second embodiment, first leg portion 114 and second leg portion 118 are preferably made from circular metal tubing. First leg portion 114 has an inside diameter that is slightly larger than the outside diameter of second leg portion 118. Thus, second leg portion 118 may be slidably received in first leg portion 114. Second leg portion 118 also has a foot pad 130 at its lower end for contact with a ground surface.

First leg portion 114 has a hole 134 cut laterally through its outer side walls. Hole-134 accommodates a slidable pin 144, having a handle 146 at its opposite end to assist in controlling the position of pin 144. A plurality of spaced-apart angled slots 140 are cut laterally through opposed side walls of second leg portion 118. When a slot 140 through second leg portion 118 is aligned with hole 134 through first leg portion 114, handle 146 may be advanced to force pin 144 through a slot 140 in second leg portion 118 and through the hole 134 in first leg portion 114, as shown in FIG. 2. Though not shown, handle 146 and pin 144 may have a detent mechanism, may be spring-loaded, or have some other feature to enhance the ability to advance pin 144 or hold it in position when inserted into a slot 140 and hole 134. The plurality of slots 140 permit selective use of the telescopic leg assemblies at various lengths.

When a vertical load is placed on the leg assembly 110, the pin 144 transfers the vertical load from the first leg portion 114 to the second leg portion 118. The angled slot 140 in second leg portion 118 tends to cause engagement between the first and second leg portions in a direction and at an angle to the vertical orientation of the leg portions. Thus, as pin 144 is made to ride lower in slot 140 through second leg portion 118, it causes an exterior wall of second leg portion 118 to press against an interior wall of first leg portion 114. In this manner, the engagement between the wall surfaces reduces wobble of the second leg portion 118 within the first leg portion 114, as with the first embodiment.

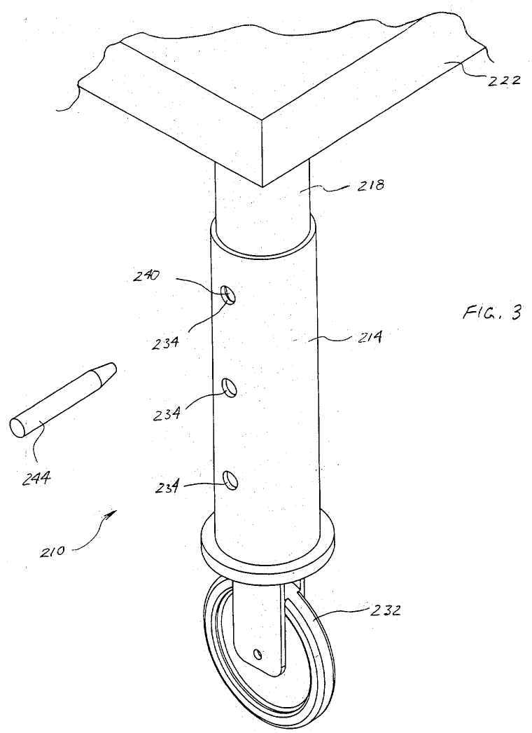

A third embodiment is shown in the FIG. 3. A telescopic leg assembly 210 has a first leg portion 214 and a second leg portion 218. In this embodiment, the second leg portion 218 is fixedly connected to a platform assembly 222, such as by conventional fasteners, welding or the like. The second leg portion 214 further includes a wheel assembly 232 at its lower end. The wheel assembly is preferably of a castor wheel type, and though not shown, may include a conventional brake system.

In this third embodiment, the first leg portion 214 is preferably made from circular metal tubing, while the second leg portion 218 is of circular solid structure. The first leg portion 214 has an inside diameter that is slightly larger than the outside diameter of second leg portion 218. This allows second leg portion 218 to be slidably received in first leg portion 214. First leg portion 214 has a plurality of spaced-apart holes 234 cut laterally through its two opposed side walls, and at least one angular slot 240 is cut laterally through second leg portion 218. When a hole 234 through opposed side walls in first leg portion 214 is aligned with an angled slot 240 cut laterally through second leg portion 218, a pin 244 may be inserted to engage and lock the two leg portions to each other. As described in the first embodiment, pin 244 may have detent mechanism or other feature to enhance its ability to stay in position, and the plurality of spaced-apart holes permits selective use of the telescopic leg assemblies at various lengths.

As with the prior embodiments, when a vertical load is placed on the leg assembly 210, the pin 244 transfers vertical load from the first leg portion 214, to the second leg portion 218. The pin is in an angled slot 240 in second leg portion 218, and therefore the vertical load tends to cause engagement between the first and second leg portions in a direction and at an angle to the vertical orientation of the leg portions. Hence, as pin 244 is made to ride higher in slot 240, it causes the exterior wall of second leg portion 218 to press against an interior wall of first leg portion 214, reducing wobble of the leg assembly 210.

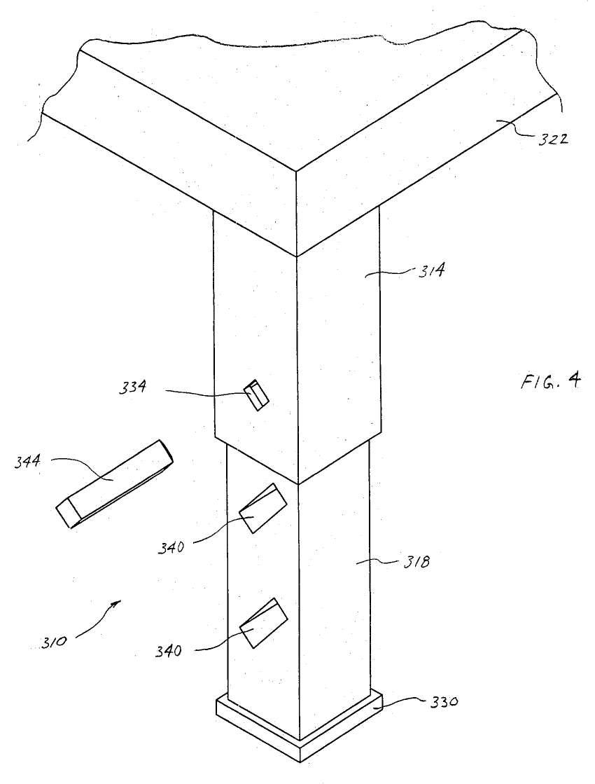

Now turning to the fourth embodiment, a telescopic leg assembly 310 having at least a first leg portion 314 and a second leg portion 318, as shown in FIG. 4. In this embodiment, the first leg portion 314 may be connected to the platform assembly 322 in any of the ways mentioned with the earlier alternative embodiments. Second leg portion 318 also has a foot pad 330 at its lower end.

In this fourth embodiment, the first leg portion 314 is preferably made from square metal or plastic tubing, and the second leg portion 318 is shown as a square solid structure, such as of metal, plastic or the like. The first leg portion 314 has interior wall dimensions that are slightly larger than the exterior perimeter wall dimensions of second leg portion 318. Thus, second leg portion 318 may be slidably received in first leg portion 314. First leg portion 314 also has at least one square hole 334 cut laterally through opposed side walls. A plurality of spaced-apart angled slots 340 are cut laterally through second leg portion 318.

When a hole 334 cut through the opposed side walls of first leg portion 314 is aligned with a slot 340 through second leg portion 318, a pin 344 may be inserted to engage and lock the two leg portions to each other. In this instance, the pin 344 is square and may be made of metal bar stock, or the like, and may have a detent mechanism or other feature to enhance its ability to stay in position when inserted. As with the prior embodiments, the corresponding pin and hole structures permit selective use of the telescopic assemblies at various lengths.

When a vertical load is placed on the leg assembly 310, the pin 344 transfers a vertical load from the first leg portion 314 to the second leg portion 318. The square pin 344 is in an angled slot 340 in the second leg portion 318, and therefore the vertical load tends to cause engagement between the first and second leg portions in a direction at an angle to the vertical orientation of the leg portions 314 and 318. Hence, as pin 344 is made to ride lower in slot 340, it causes an exterior wall of second leg portion 318 to press against an interior wall of first leg portion 314, reducing wobble and increasing the stability of the leg assembly 310.

It will be appreciated that the platform assemblies and self-stabilizing telescopic leg assemblies of the present invention may be constructed in various configurations. A variety of materials and shapes of tubing or solid structures may be used, and components may be joined in any number of conventional manners, such as by welding or with suitable fasteners. It also should be apparent that at least one of the leg portions must have a plurality of spaced-apart holes or slots laterally cut through it, although both leg portions may have more than one hole or slot cut through them, as long as one leg portion has at least one hole and the other leg portion has at least one slot.

Finally, it should be understood that while preferred embodiments have been described herein, any variety of fastening means and suitable materials of construction and dimensions may be used to satisfy the particular needs and requirements of the end user. It will be apparent to those skilled in the art that various modifications and variations can be made in the design and construction of a self-stabilizing telescopic leg assembly without departing from the scope or spirit of the present invention. Other embodiments of the invention will be apparent to those skilled in the art from consideration of the specification and practice of the invention disclosed herein.

What is claimed is:

1. A telescopic leg assembly comprising:
at least a first leg portion comprising at least one hole passing laterally through the first leg portion;
at least a second leg portion slidably engaging the first leg portion and further comprising
at least one angled slot passing laterally through the second leg portion;
at least one pin adapted to simultaneously engage said at least one hole passing laterally through the first leg portion and said at least one angled slot passing laterally through the second leg portion; and
wherein when the leg assembly is in a vertical orientation, the pin transfers a vertical load from the first leg portion to the second leg portion and causes engagement between the first and second leg portions in a direction at an angle to the vertical orientation of the leg portions.

2. A telescopic leg assembly in accordance with claim 1, wherein said leg has at least two predetermined lengths.

3. A telescopic leg assembly in accordance with claim 1, wherein at least a portion of said at least one second leg portion is slidably received in said at least one first leg portion.

4. A telescopic leg assembly in accordance with claim 3, wherein said at least one second leg portion has a plurality of spaced apart angled slots passing laterally through said second leg portion.

5. A telescopic leg assembly in accordance with claim 3, wherein said at least one first leg portion has a plurality of spaced apart holes passing laterally through said first leg portion.

6. A telescopic leg assembly in accordance with claim 1, wherein said at least one second leg portion further comprises a foot pad.

7. A telescopic leg assembly in accordance with claim 1, wherein said at least one second leg portion further comprises at least one wheel.

8. A telescopic leg assembly in accordance with claim 1, wherein at least a portion of said at least one first leg portion is slidably received in said at least one second leg portion.

9. A telescopic leg assembly in accordance with claim 8, wherein said at least one first leg portion has a plurality of spaced apart holes passing laterally through said first leg portion.

10. A telescopic leg assembly in accordance with claim 8, wherein said at least one second leg portion has a plurality of spaced apart angled slots passing laterally through said second leg portion.

11. A telescopic leg assembly in accordance with claim 1, wherein said at least one first leg portion further comprises a foot pad.

12. A telescopic leg assembly in accordance with claim 1, wherein said at least one first leg portion further comprises at least one wheel.

13. A platform assembly having at least one platform and a plurality of telescopic leg assemblies connected to said at least one platform; each of said plurality of leg assemblies comprising;
at least a first leg portion further comprising at least one hole passing laterally through the first leg portion;
at least a second leg portion slidably engaging the first leg portion and further comprising at least one angled slot passing laterally through the second leg portion;
at least one pin adapted to simultaneously engage said at least one hole passing laterally through the first leg portion and said at least one angled slot passing laterally through the second leg portion; and
wherein when the platform assembly is assembled for use with the platform in a horizontal plane, each leg assembly is in a vertical orientation and each pin transfers a vertical load from a said first leg portion to a said second leg portion and causes engagement between said first and second leg portions in a direction at an angle to the vertical orientation of the leg assembly portions.

14. A platform assembly in accordance with claim 13, wherein each said leg assembly has at least two predetermined lengths.

15. A platform assembly in accordance with claim 13, wherein at least a portion of said at least one second leg portion of each leg assembly is slidably received in said at least one first leg portion of each leg.

16. A platform assembly in accordance with claim 15, wherein said at least one second leg portion of each leg assembly has a plurality of spaced apart angled slots passing laterally through said second leg portion.

17. A platform assembly in accordance with claim 15, wherein said at least one first leg portion of each leg assembly has a plurality of spaced apart holes passing laterally through said first leg portion.

18. A platform assembly in accordance with claim 13, wherein said at least one second leg portion of each leg assembly further comprises a foot pad.

19. A platform assembly in accordance with claim 13, wherein said at least one second leg portion of each leg assembly further comprises at least one wheel.

20. A platform assembly in accordance with claim 13, wherein at least a portion of said at least one first leg portion of each leg assembly is slidably received in said at least one second leg portion of each leg assembly.

21. A platform assembly in accordance with claim 20, wherein said at least one first leg portion of each leg assembly has a plurality of spaced apart holes passing laterally through said first leg portion.

22. A platform assembly in accordance with claim 20, wherein said at least one second leg portion of each leg assembly has a plurality of spaced apart angled slots passing laterally through said second leg portion.

23. A platform assembly in accordance with claim 13, wherein said at least one first leg portion of each leg assembly further comprises a foot pad.

24. A platform assembly in accordance with claim 13, wherein said at least one first leg portion of each leg assembly further comprises at least one wheel.

25. A platform assembly in accordance with claim 13, wherein at least one of said leg assemblies is foldably connected to said at least one platform.

26. A platform assembly in accordance with claim 13, wherein at least one leg portion of at least one of said leg assemblies is fixedly connected to said at least one platform.
